(19) United States
(12) Patent Application Publication
(10) Pub. No.: US 2010/0287162 A1
(43) Pub. Date: Nov. 11, 2010

(54) METHOD AND SYSTEM FOR TEXT SUMMARIZATION AND SUMMARY BASED QUERY ANSWERING

(76) Inventor: Sanika Shirwadkar, (US)

Correspondence Address: SANIKA SHIRWADKAR, 1570 VISTA CLUB CIR, APT. 203, SANTA CLARA, CA, 95054, US

(21) Appl. No.: 12/413,518

(22) Filed: Mar. 28, 2009

Related U.S. Application Data
(60) Provisional application No. 61/040,152, filed on Mar. 28, 2008.

(51) Int. Cl. G06F 17/30; G06F 17/21

(52) U.S. Cl. 707/740; 715/254; 707/E17.09; 707/750; 707/769

(57) ABSTRACT

A method and system for generating answers to questions based on electronic data summary which is itself derived on context and semantics of a corpus of authoritative documents and its subsequent usage is disclosed. The method and system provides for generating a taxonomy of concepts, assigning unique-identifiers and weights to the taxonomy concepts using a given corpus of electronic data, using the taxonomy to identify the semantics of the document to be summarized, generating an ontology from a summarized authoritative text, having the ontology generation and the summary generation in a feedback loop, selecting text from a given document based on the weights of unique-identifiers in the taxonomy/ontology, sentences as a summary and pruning of the list based upon an entropy threshold, and the presence of a probability distribution, publishing of the summary in a known format on server or any other software/hardware platform with or without monetization for consumption, usage of the summary to generate answers which can be configured using an ontology and thus prevent denial of information/information overload.

### CROSS-REFERENCE TO RELATED APPLICATIONS

This application claims the benefit of PPA Ser. No. 61/040,152 filed on Mar. 28, 2008 by the present inventor, which is incorporated by reference.

### TECHNICAL FIELD

The present invention relates generally to computer software systems. In particular, an embodiment of the invention relates to a method and system for summarizing input text(s) and using the summaries to answer user queries for quicker information dispersal.

### BACKGROUND ART

Electronic data (documents containing text, and textual captions/tags parts of audio/video/images etc.) usually contains ‘meta-data’, i.e. data describing data, generated to help readers understand what is described in the document. This meta-data, is generated using the title of the document, the keywords that are used in the document, or using some of the sub-titles/headings of the document. This meta-data can then be embedded in the document as its property (for example, Microsoft Word documents have a property which can store document related information). However, the problem of this approach is that the keywords give the idea about only one document. Even if the user searches documents using a search engine, the number of documents searched is large and as a result the user needs to go through the entire set of documents and then arrive at an answer to the initial query.

In certain documents for the web (i.e. web pages), search engines derive all the words used in the web documents (i.e. web pages), and index the document based on the words. In this way the words of the document become the meta-data for the document. This meta-data then works as an index for a user, who wants to understand the document without going over the details of the document. In this case, the web search engine may index the document based on certain keywords that do not have much relevance in terms of the context of the document. For example, a page may be dedicated to Shakespeare in general and has not much relevance in terms of the Shakespeare's drama Hamlet. The onus to find the correct web page hence rests on the human reader who must not only provide the correct keywords while searching, but also go through (read and understand) the web pages that are shown by the web engine, in order to find the web page that has the required information. The user then needs to go over the web page(s) and then form an answer to the question.

Certain systems exist for answering questions based on a corpus of documents. However, the answer calculation is totally dependent on size of the corpus, and hence does not scale since as the number of documents in the corpus increases, the storage and computational requirements increase.

Thus these systems do not prevent ‘Denial of Information’ where the human reader is flooded with information in form of hundreds of documents or web pages that may not be relevant, thus resulting in wastage of user, network bandwidth and client/server computing time.

Some of such systems may also be the cause of information overload, where an excessive amount of information is presented to the human reader, upon whom falls the time-consuming task of reading and analyzing all this information in order to discover the needed knowledge or answer.

All these systems lack the ability to provide more detailed document search by taking into account a limited corpus of documents and yet provide a fast, concise, complete and understandable answer based on document content summary that enables a human reader to quickly understand the topic at hand.

Accordingly, a need exists for a method and system which summarizes input text(s) and provides semantically generated comprehensive answers to a user query using these summaries or semantic excerpts from a limited size corpus that can be used effectively by human readers in quick understanding, thus preventing a ‘Denial of Information’ and loss of computing and network resources.

### SUMMARY OF THE INVENTION

In accordance with the present invention, there is provided a method and system for summarizing input text and for semantically generating answers to a query that can be used effectively by man or machine readers in quickly understanding the context of the document, thus preventing a ‘Denial of Information’. The invention also improves usage of computing and network resources.

For instance, one embodiment of the present invention provides a method and system for extracting the contextually important sentences from a document by comparing that document against a corpus of authoritative documents that have been generated or edited collectively by a number of users. These key sentences then form the semantic summary of the document. These summaries are stored along with the document or it's Uniform Resource Identifier, so that they can be retrieved whenever the document is retrieved.

In one embodiment, the pre-processed document summaries are used as a corpus by a ‘Query Processing’ mechanism that takes user queries and returns an answer to the query.

In one embodiment, the semantic groups of a language (such as words with similar meanings) as found in a given taxonomy such as a thesaurus are assigned unique-identifiers. Thus a given language is converted into a semantic space of unique-identifiers that are associated with the root terms of the provided taxonomy. These root terms themselves are then associated with leaf terms that are words that carry similar meaning though in different nuance.

In another embodiment, the taxonomy arranges similar concepts together, thus similar concepts have unique-identifiers that are close to each other creating a semantic-group, where each semantic group is represented by the root term, and the associated terms are represented as leaf terms. Representing semantic concepts of a language through unique-Identifiers allows for symbolic and mathematical manipulation. Thus same identifiers can be used for different languages to denote similar concepts. In this entire process, common words like—‘the, is, was, then, that’ etc. are ignored.

For example, let us consider prime numbers used as unique-identifiers, a thesaurus used as a means of taxonomy, and English as the language in consideration. The concept word ‘blue’ (where ‘blue’ may be the root term; and, bluish’ may be the associated leaf terms,) is assigned the identifier prime 2 (with a weight of 1), and, the concept word ‘color’ (and the associated semantically similar words like ‘hue’, ‘tinge’ etc.) is assigned the identifier—prime number 3 (with a weight of 2), and the thesaurus word ‘sky’ is assigned the identifier—prime number 5 (with a weight of 3). These prime numbers are then used to generate a semantic weight for each sentence. For example, the sentence—‘The color of sky is blue’, will be assigned the weight of 6 based on the addition of 2 (color), 1 (blue), and 3 (sky).

It is to be noted that these examples are for the purpose of explaining the concept and should not be taken as a limitation on the proposed invention.

The unique-identifiers assigned to the words cover the entire semantic space of a word. For example, ‘bluish’ is also assigned the prime number 2 (with the same weight as blue). Hence the sentence, ‘The sky has a bluish tinge’, is considered as semantically equivalent to the earlier sentence—‘The color of sky is blue’, and is therefore assigned the same weight. This approach is helpful in summarizing documents where the number of sentences needs to be reduced drastically and to convey the meaning of the document in very few sentences.

In another embodiment, the documents are indexed using a search engine. Each document is then retrieved using the search engine. The words of the preprocessed and summarized documents are used to generate domain ontology. This domain ontology consists of terms that are extracted from the pre-processed documents, the different senses of these words, and their inter-associations and relationships. The ontology helps provide an indication of the context in which that particular word is used.

In an embodiment, the weight of a word's unique-identifier is calculated based on factors such as the total number of documents in the domain, number of documents in which the word is found, total number of associations for the word, and total number of word senses.

The given global unique-identifier-weight advantageously provides information about the nuances or senses that exist for a given word. The more the number of nuances that exist for a word, the less its semantic decisiveness for a summary, thus the less is its weight. In an embodiment, the weights of words are averaged over successive rounds of calculations. Thus, if new documents get added to the corpus, they also contribute to the new weight. In addition, the weights get refined as time progresses. Thus the ‘Summarizing’ process along with the ‘Ontology generation’ form part of a feedback loop, which can also be interpreted as a ‘Maximum Likelihood Estimator’. In another embodiment, each word is assumed to follow a probability distribution in terms of its meaning. The weights are assumed to be the random variable that represents this probability distribution. These weights get refined over a period of time, but they always belong to some probability distribution. Each document is therefore a joint probability distribution and each ‘good’ summary is therefore has a similar probability distribution. Therefore, the weights of all the words in a document and the weights of all words in a summary can be compared with the help of standard statistical tests such as Shapiro-Wilk test, Anderson-Darling test, q-q plot etc.

In another embodiment, each word weight gets updated/refined after a run of the summarizer since new documents may be added to the corpus or new user generated summaries may get available. Thus all the word weights may approach a given word related optimal weight stability. Thus after each run, the weight need to be updated with the new weight, so that over a period of runs, the weights approach the stability.

In another embodiment, the created summaries are used to create an ontology which in turn is used to calculate weights for summary generation in a later round. In another embodiment, the weight of a unique-identifier for a given input document is calculated by using the local frequency of the unique-identifier and the global unique-identifier-weight.

In one embodiment, a document's summary is generated by using a pre-generated summarized authoritative text. This database of documents is processed to cluster documents contextually similar to the input document. This database can be a search engine database but not limited to it.

In another embodiment, since a search for unique-identifiers/root terms in a semantic-structure (for example a sentence, paragraph, tags, key words etc. are semantic structures since they give information about the meaning of a document. Throughout the document, the word ‘sentences’ is interchangeably used with semantic-structures) can result in unique-identifiers/multiple words with multiple and redundant meanings, the unique-identifiers in a given semantic-structure are checked with the unique-identifiers in the next semantic-structure, and only those unique-identifiers are selected for a given semantic-structure which have unique-identifiers from the same semantic groups in the next sentence. This ensures that multiple meanings that can get associated with a semantic-structure are removed. For example, if the first sentence is—“I went with my office colleagues for entertainment”. If the second sentence is—“We saw a movie and then had dinner at a restaurant”. Then in the first sentence, the words that will be looked up in the database are ‘office’, ‘colleagues’ and ‘entertainment’. In the second sentence, the actual entertainment is described through ‘movie’:‘dinner’ and ‘restaurant’. Thus the particular nuance of the word ‘entertainment’ where it pertains to ‘movies, drama, music’ etc. will be picked up.

However, if the first sentence is—‘The people at my office were entertaining the idea of moving to a new location’, and the second sentence is—‘The location most probably will be in the downtown’. Then the word ‘entertaining’ has a meaning different from watching ‘movies’ or having ‘dinner’ at a ‘restaurant’. Thus this particular meaning of entertainment and hence the associated unique-identifier will not be taken into consideration. Thus the unique identifier associated with the secondary meaning of ‘entertaining’ i.e. ‘to consider’ will be taken into account.

In another embodiment, an input document's (to be summarized) associated semantic-structure (for example a sentence, paragraph, tags, key words etc. are semantic structures since they give information about the meaning of a document) are then identified and assigned weights also referred to as semantic-structure-weights based on the weights of the unique-identifiers for the constituent words.

In an embodiment, the semantic-structures with the optimal weights are selected as candidates for generation of summary.

In another embodiment, the document is processed to extract the headers and titles semantically and structurally placement-wise important content to generate summary based on the structure of the document. For example, the first paragraph, the last paragraph, the first and last sentences of each paragraph are also extracted to generate structure-based summary.

In yet another embodiment, higher semantic scores are assigned to the structurally significant semantic-structures. The structure-based summary is compared with the summary generated using unique-identifiers, and the common semantic-structures are assigned with higher semantic scores than the other semantic-structures.

In another embodiment, these semantic-structures are classified based on the entropy of the semantic-structures. For example, in one of cases if the number of unique-identifiers in a semantic-structure is higher for a very small number of words then that sentence is supposed to have higher entropy.

These entropy parameters are used to identify the large/complex and small/simple sentences for a document. The entropy information preserves sentences that optimally follow some probability distribution.

In another embodiment, the entropy of a semantic-structure is calculated based on factors such as the size of the sentence in terms of number of words and the number of unique-identifiers (i.e. unique concepts) found in the sentence, and the weight of the sentence (obtained by adding the weights of its constituent unique-identifiers.).

In yet another embodiment, the semantic-structures are parsed using Natural Language Processing (NLP) techniques for finding out the possible grammatical parts of the sentence.

In one embodiment, the complex/long semantic-structures of a particular document are replaced by the contextually similar but simpler/smaller semantic-structures from other documents, if they have the same subject, and have at least the same unique-identifiers.

In yet another embodiment, sentences derived from different parts of the document are grouped together if they are semantically similar. For example, this can be done by calculating cosine similarity of sentences or by any other known method.

In another embodiment, the semantic-structures (i.e. sentences, paragraphs etc.) that are identified to contain the key unique-identifiers are again used for searching similar semantic-structures in the database. The similar semantic-structures are then used to substitute existing sentences to generate an alternative summary.

In another embodiment, the context used for summary generation is based on user preferences. Therefore, the context can be local machine/Internet and is stored on a database.

In another embodiment, if the user belongs to a given social network, then the weights for the social network will be used in generating the summary. Thus the answer (which depends upon the available summaries) to a given user question will differ, depending upon which social network the user belongs to.

In one embodiment, a user or a social network may modify the summary to improve quality. These improved summaries are verified and then further input into the system for improving weights of the words. This improves the overall quality of summaries.

In another embodiment, the user may choose to select a social network to answer a question or summarize a document. In another embodiment, the system based upon user preferences and previous history may provide a user with the best social network to summarize a document, or to answer a query.

In another embodiment, based upon their expertise and ratings, summary writing social networks or users may be provided access to the most suitable consumers.

In another embodiment, reward systems may be employed for the best summaries or social network(s) providing the best summary. The reward systems may or may not be monetary in nature.

In yet another embodiment, the length of summary can be selected by changing the threshold value, which allows summary from one sentence to multiple sentences.

In another embodiment, the summary can be reformatted for representation in various ways based on user preferences, the structure in which the summary is stored, and the location that it is stored. Thus the summary can be stored as part of the electronic data or stored along with the Uniform Resource Identifier (URI) of the electronic data.

In another embodiment, the summary can be used in a semantic browser/search engine/resource locator that fetches summary of a document when the corresponding URI/keywords are provided.

In another embodiment, the ‘Question Processing’ mechanism expands user questions based on the ontology. These expanded questions are used to lookup the database for matching pre-processed summaries.

In one embodiment, a finite number of best matching ‘summaries’ are retrieved. In another embodiment, this finite number is usually between the top 5-20 documents.

In another embodiment, the retrieved summaries (as mentioned in the above paragraph) are processed through a voting mechanism, where different algorithms optimally select the sentences that are good answers to the question, and the voting mechanism then chooses the sentences which are present in the majority of the answers.

In one embodiment, the different mechanisms include cosine-based, clustering based, and so on.

In another embodiment, the chosen sentences are processed using NLP techniques for providing more coherence to the answers.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram illustrating various processing parts used during the generation of an answer to a question.

FIG. 2 is a flowchart of steps performed during initial summarization of a document.

FIG. 3 is a flowchart of steps performed for generating the answer to a question based on the stored document summaries.

FIG. 4 is a flowchart for the steps performed to optimize the system based on user provided answers to the question.

FIG. 5 is a flowchart for the steps performed for generating the ontology.

FIG. 6 is a block diagram of an embodiment of an exemplary computer system used in accordance with one embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components and circuits have not been described in detail as not to unnecessarily obscure aspects of the present invention.

### Notation and Nomenclature

Some portions of the detailed descriptions, which follow, are presented in terms of procedures, logic blocks, processing and other symbolic representations of operations on data bits within a computer system or electronic computing device. These descriptions and representations are the means used by those skilled in the data processing arts to most effectively convey the substance of their work to others skilled in the art. A procedure, logic block, process, etc., is herein, in generally, conceived to be a self-sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussions, it is understood that throughout discussions of the present invention, discussions utilizing terms such as “generating” or “modifying” or “retrieving” or the like refer to the action and processes of a computer system, or similar electronic computing device that manipulates and transforms data. For example, the data is represented as physical (electronic) quantities within the computer system's registers and memories and is transformed into other data similarly represented as physical quantities within the computer system memories or registers or other such information storage, transmission, or display devices.

### Automatic Generation of Answers

The method and system of the present invention provide for the generation of summary and generation of answers based on summary. According to the exemplary embodiments of the present invention, the system is implemented to suite the requirements of a user who is searching for documents and does not have the time to read the entire search results before judging that it is suitable for the user's purposes. Thus, according to such embodiments, it is possible to generate a summary or a summarized answer to user question/query.

According to one embodiment, an initial taxonomy is created. This taxonomy is language independent since a concept is represented through unique identifiers. The different root words in this taxonomy are assigned unique identifiers. In an embodiment of the invention, the words are then associated with unique identifiers. It will be clear to one skillful in the art, that these unique-identifiers actually represent semantic concepts of a language. However, these unique-identifiers are subject to easier manipulation as compared to words.

In another embodiment, weights are assigned to individual unique-identifiers based on the nuances of meaning that they exhibit in the corpus of initial documents. In an embodiment, this corpus is taken from the authoritative sources such as Wikipedia. Since a large number of knowledgeable people contribute to such corpus, it represents collective intelligence and sufficiently authoritative knowledge of a given domain. The weights/relations obtained from these authoritative sources are used to calculate summary information for other documents that were not present in the original corpus. The system uses optimal and valid data relationships derived from the authoritative sources. Thus it prevents the excessive time and resources that will otherwise be required for crawling the entire internet for all available data and then calculating the relationships and weights for all the words

In another embodiment, the list of unique-identifiers associated with a sentence is pruned by searching for similar unique-identifiers that occur in the adjacent sentences. This search removes words with polysemy i.e. words with similar roots and having somewhat similar meanings.

According to another embodiment, the sentences of document to be summarized are extracted, and each sentence is assigned a weight based on the weights of the constituting unique-identifiers (i.e. the words).

In another embodiment, an entropy function is used to find sentences that have less number of words in it and high number of high frequency unique-identifiers in them. The actual number of sentences available is also an input to this function. As a result of this entropy calculation, the sentences that are complex and convey less meaning are removed from the list.

In another embodiment, NLP is used only used optimally (for example at the end of summary generation) since NLP techniques are computationally expensive.

In yet another embodiment, similarity of sentences is calculated. This is to provide some coherence to the summary that is generated from different parts of the document.

According to one embodiment, the structure of the document is analyzed to give a separate summary, and the summary obtained is combined with the summary generated earlier.

According to another embodiment, the summary is stored in the database along with the Uniform Resource Identifier (URI) of the document. This database can then be used to display summaries of document.

According to another embodiment, these summaries may get updated as more documents get added to the database and the current context is changed. This summary also gets refined as the weights of words are refined over a period of time.

According to another embodiment, the document summaries can be generated to a given level of detail. The level of detail is given by the number of sentences that are allowed in the user preferences.

In an embodiment, the summary of a document is used to generate answers to a question.

In another embodiment, the answers are derived by processing pre-calculated document summaries and then choosing the relevant sentences based on the sentences chosen by diverse systems such as clustering techniques and cosine based search.

In another embodiment, the summaries chosen are from the top 5-20 best search results of the question list. The top 5-20 results ensure that best recall and precision is maintained for the answer.

### Exemplary System in Accordance with Embodiments of the Present Invention

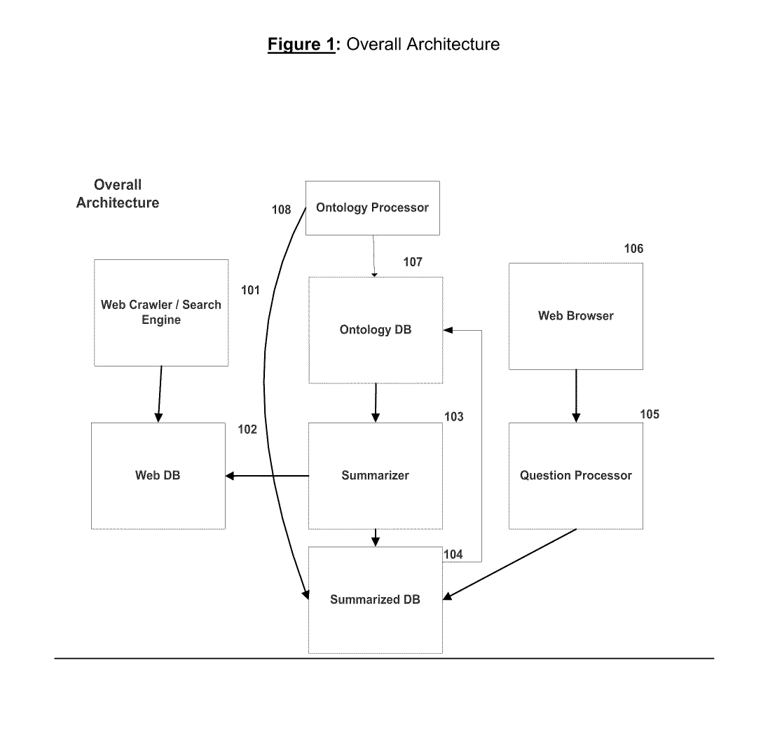

FIG. 1 represents an answer generation system according to one embodiment of the present invention. Referring to FIG. 1, there is shown a Web Crawler/Search Engine server 101 that holds all the documents (which serve as input for generating the summary of a document), a document database 102, a summarizer 103, a summarizer database 104, a Question Processor 105, a Web Browser 106, an Ontology database 107 and an Ontology Processor 108.

According to one embodiment, the Summarizer 103 summarizes the documents downloaded by the Web Crawler 101 and stored in Web DB 102, and stores the summary in summary database 104. The Ontology Processor 108 generates the Ontology DB 107 based on the summary database 104. The Ontology Database 107 will be used in subsequent summarization rounds for weight calculation and also to help the user during summary retrieval. The Question Processor 105 reads the user questions and creates an answer to the question based on the document summaries, which are then displayed by the Web Browser 106.

According to one embodiment, the summary engine 103 is also responsible for creating taxonomy of concepts and assigning unique-identifier to the different root words.

According to another embodiment, the summary engine 103 also generates a ‘topic summary’ by taking into account all similar documents.

According to one embodiment, summarizer can convert the summary to be consumed either by humans or by machines. For humans, the summary is in the form of a User Interface. In case of a machine, the summary is in the form of an openly available and understood structure.

### Exemplary Operations in Accordance with Embodiments of the Present Invention

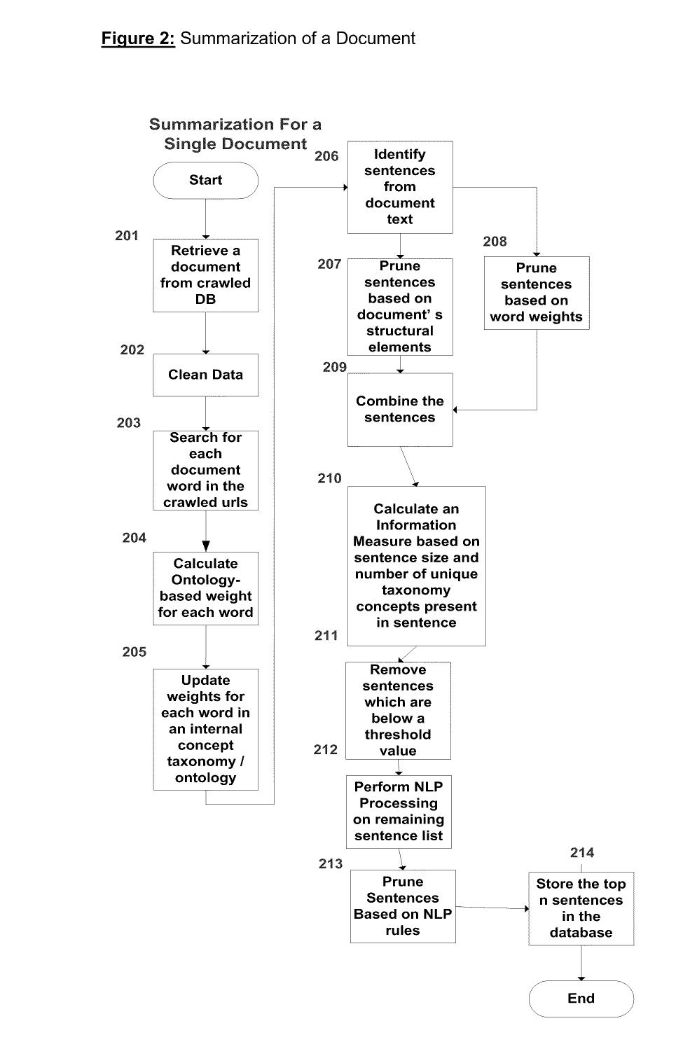

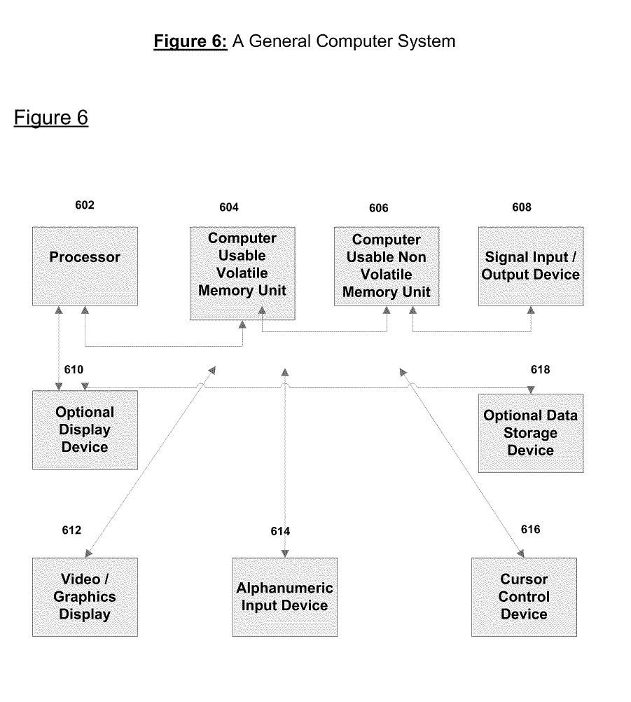

FIGS. 2 to 5 are flowcharts of computer-implemented steps performed in accordance with one embodiment of the present invention for providing a method or a system for generating summary based answers to questions. The flowcharts include processes of the present invention, which, in one embodiment, are carried out by processors and electrical components under the control of computer readable and computer executable instructions. The computer readable and computer executable instructions reside, for example, in data storage features such as computer usable volatile memory (for example: 604 and 606 described herein with reference to FIG. 6). However, computer readable and computer executable instructions may reside in any type of computer readable medium. Although specific steps are disclosed in the flowcharts, such steps are exemplary. That is, the present invention is well suited to performing various steps or variations of the steps recited in FIGS. 2 to 5. Within the present embodiment, it should be appreciated that the steps of the flowcharts may be performed by software, by hardware or by any combination of software and hardware.

### The Summary Engine—Generation, Storage and Presentation of Summary

FIG. 2 consists of the steps performed by the summary engine in order to generate a document summary.

In step 201, a document is read from the database. The document data is cleaned in 202 and each word of the cleaned document is searched in the available web database in step 203. In step 204, an Ontology-based weight is calculated for each word, where the ontology may be available from generally available databases or generated using various associative rules on a given database. In step 205, this weight is stored in the available word taxonomy/ontology.

In step 206, the document sentences are read. In step 207, the sentences of the document are pruned based on document structure. In step 208, the weights of the each sentence of the document are used to prune the sentence list.

In step 209, the sentences from the previously created list are merged with sentences that are created during structural summarization.

In step 210 and 211, the entropy of the sentences is calculated, and sentences are selected/rejected based on the entropy value. This makes the summary list shorter.

In step 212, the list of sentences is parsed by a Natural Language Parser to identify the Parts-Of-Speech of the words of the sentences. In step 213, the sentences are pruned based on Natural Language Processing (NLP) rules.

In step 214, all (top n) the sentences are stored in the database in the form of a summary.

### Summary Based Answering for a Question

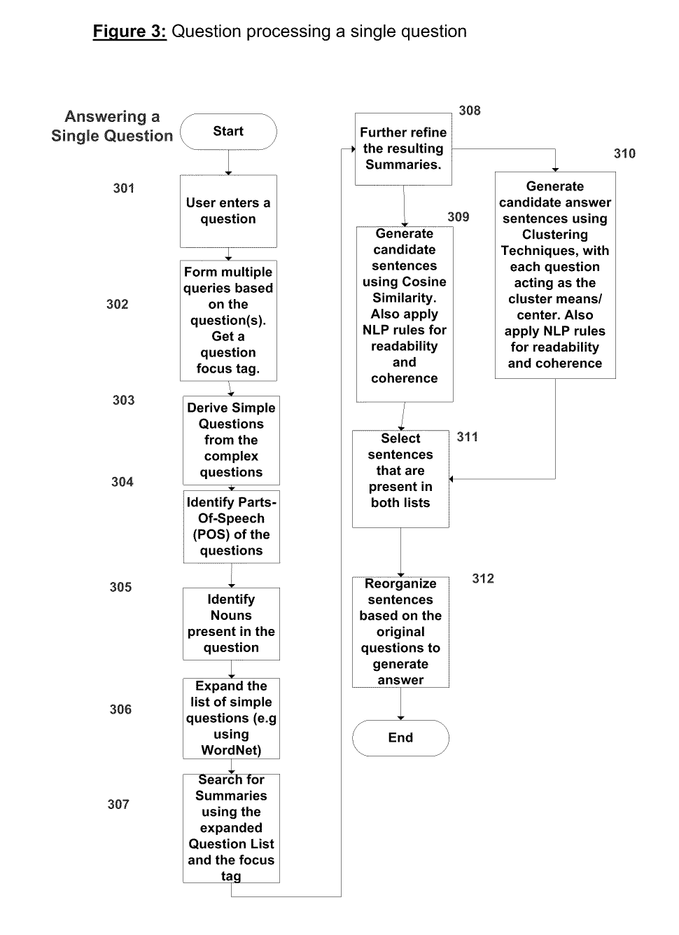

FIG. 3 consists of the steps performed by a question processor when generating answers for a user request/query. In step 301, user enters a question. In step 302, the question is expanded and multiple questions are formed. In step 303, simple questions are derived from the complex questions. In step 304, the Parts-Of-Speech of the questions are determined. The nouns present in the questions are then stored to be used later in the process. The existing questions are further expanded using ontology in step 306. The expanded list of questions and an optional focus tag (key word) are used to search for ‘Summaries’. The results obtained are further refined using in step 308. Step 309 and Step 310 are two different methods for sentence selection. 309 uses Vector Based method (e.g. Cosine Similarity) to identify the best sentences. Step 310 uses standard clustering techniques, with question acting as the cluster mean.

In Step 311, the sentences obtained from the earlier steps of 309 and 310 are merged together, which are then further re-organized based on the original questions in Step 312 to generate an answer. This answer can be changed by using a different tag from a given taxonomy/ontology.

### Answer Optimization

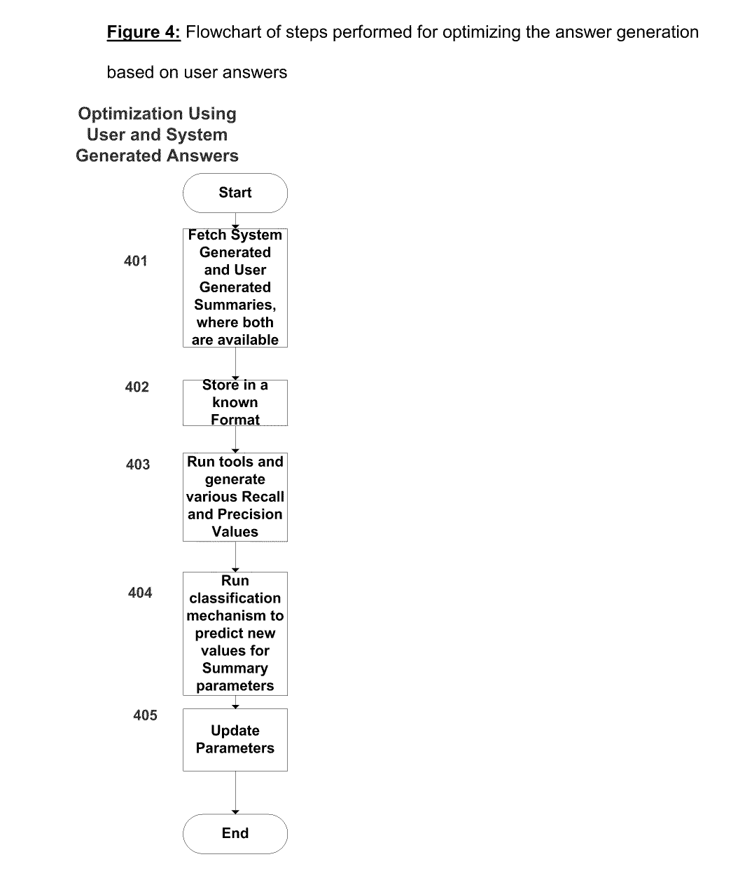

FIG. 4 shows the steps performed to optimize the system based on user answers. The user answers (summaries) and the corresponding machine generated answers are retrieved from the database in Step 401. In step 402, these answers are stored in a format suitable for tools such as Rouge etc., which uses different metrics to measure the quality of a machine generated answer. Each summary is also checked wherein its sentence weights are checked whether they follow a probability distribution or not. The actual tools are run in Step 403. The values obtained are used to set the original values for summaries in Step 404.

### Ontology Construction Process

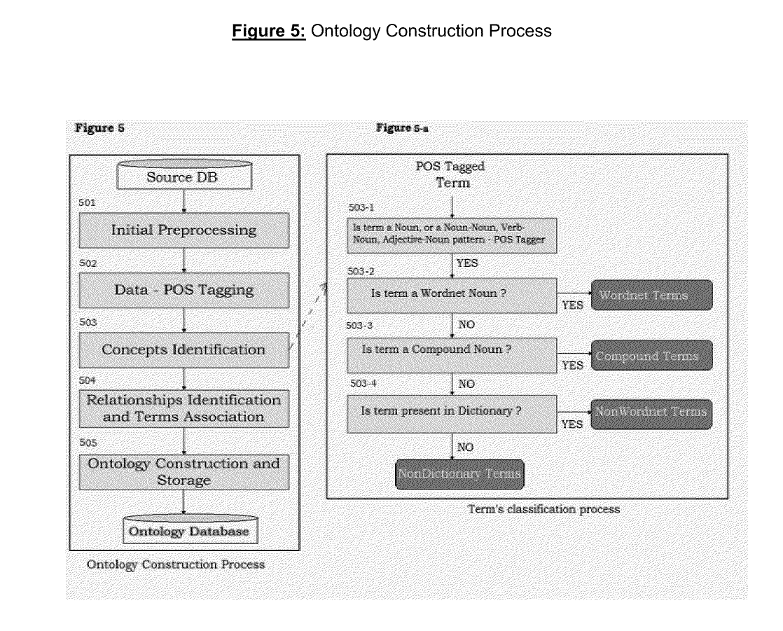

FIG. 5 consists of the steps performed to generate an Ontology based on the given text database.

In step 501, the database text accessed and basic cleaning operations are performed on the data. In step 502, the text is tagged with their respective part of speech (verb, noun, etc.). In step 503, using the POS tagged text, the potential concept key terms are extracted, classified and stored along with the corresponding frequency counter. The frequency counter keeps track of the number of times the term occurs in the given database. FIG. 5-a shows in detail the term classification process of step 503. The extracted terms are classified into categories such as following: [1] Wordnet term: In Step 503-2, if the extracted term exists in the dictionary and exists in the Wordnet as a noun, it is classified into this category. (e.g.: terms such as truck, computer, etc.). If the extracted term is in plural form, it is converted to a singular form. The terms in this category act as the already-established concepts. [2] Non-Wordnet term: In Step 503-4, if the extracted term does not exist in the Wordnet, but is tagged as a noun by the POS Tagger and exists in the dictionary, it is classified into this category (e.g.: terms such as colorant, Sony, etc.). [3] Compound term: In Step 503-3, if the extracted term is a compound term (that is a noun-noun, verb-noun or adjective-noun pattern) and does not exist in the Wordnet, it is classified into this category (e.g.: terms such as software design, Ralph Lauren, etc.). [4] Non-Dictionary term: In Step 503-4, if the extracted term does not exist in the dictionary, it is classified into this category. (e.g.: terms such as subwoofer or Pentium, or spelling errors such as polyster). All the rest of the terms are ignored. The resulting categorized terms are further pruned (for example, only those terms above a certain frequency threshold are considered, plural-singular forms of a term are merged, etc.).

Step 504 involves operations to identify and extract the associations or semantic relationships between the concepts. For each qualifying concept, a logical concept cluster is formed. Each concept cluster consists of the concept term, the associated concept terms, and the relationships between these concepts. Some of the techniques used for relationships identification and terms association are: discovery of relations using Wordnet, association rule mining, terms' co-occurrence frequency based associations, frequency based discovery and associations for compound terms or phrases, relating compound nouns using the head noun term, etc.

In step 505, the logical concept clusters are represented using a standard format such as XML. These are used to construct the ontology, that is then stored in a database for further use.

### Exemplary Hardware in Accordance with Embodiments of the Present Invention

FIG. 6 is a block diagram of an embodiment of an exemplary computer system 600 used in accordance with the present invention. It should be appreciated that the system 600 is not strictly limited to be a computer system. As such, system 600 of the present embodiment is well suited to be any type of computing device (for example: server computer, portable computing device, mobile device, embedded computer system, etc.). Within the following discussions of the present invention, certain processes and steps are discussed that are realized, in one embodiment, as a series of instructions (for example: software program) that reside within computer readable memory units of computer system 600 and executed by a processor(s) of system 600. When executed, the instructions cause computer 600 to perform specific actions and exhibit specific behavior that is described in detail below.

Computer system 600 of FIG. 6 comprises an address/data bus 610 for communicating information, one or more central processors 602 couples with bus 610 for processing information and instructions. Central processing unit 602 may be a microprocessor or any other type of processor. The computer 600 also includes data storage features such as a computer usable volatile memory unit 604 (for example: random access memory, static RAM, dynamic RAM, etc.) coupled with bus 602, a computer usable non-volatile memory unit 606 (for example: read only memory, programmable ROM, EEPROM, etc.) coupled with bus 610 for storing static information and instructions for processor(s) 602. System 600 also includes one or more signal generating and receiving devices 608 coupled with bus 610 for enabling system 600 to interface with other electronic devices. The communication interface(s) 608 of the present embodiment may include wired and/or wireless communication technology. For example, in one embodiment of the present invention, the communication interface 608 is a serial communication port, but could also alternatively be any of a number of well known communication standards and protocols, for example: Universal Serial Bus (USB), Ethernet, FireWire (IEEE 1394), parallel, small computer system interface (SCS), infrared (IR) communication, Bluetooth wireless communication, broadband, and the like.

Optionally, computer system 600 can include an alphanumeric input device 614 including alphanumeric and function keys coupled to the bus 610 for communicating information and command selections to the central processor(s) 602. The computer 600 can include an optional cursor control or cursor-directing device 616 coupled to the bus 610 for communicating user input information and command selections to the central processor(s) 602. The system 600 can also include a computer usable mass data storage device 618 such as a magnetic or optional disk and disk drive (for example: hard drive or floppy diskette) coupled with bus 610 for storing information and instructions. An optional display device 612 is coupled to bus 610 of system 600 for displaying video and/or graphics.

As noted above with reference to exemplary embodiments thereof, the present invention provides a method and system for generating answer to a question(s) based upon document summaries. The method and system provides for generation of summary and answers based on summary, its publication in a suitable format, and its usage in preventing denial of information/information overload.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of invention and its practical application, to thereby enable others skilled in the art to best utilize the invention and various embodiments with various modifications as are suited to the particular use contemplated. It is intended that the scope of the invention to be defined by the claims appended hereto and their equivalents.

What is claimed is:

1. A method comprising:
summarizing text(s), and using the generated single-source or multi-source summary as an answer to an input query, where summarization is based on a pre-generated context of a summarized authoritative texts corpus,
whereby said summary or answer prevents ‘denial of information’ and information overload when plurality of electronic data is available.

2. The method of claim 1, wherein the generation of said context further comprises: classifying input document key terms into unique concept groups using a taxonomy, where each concept is represented by a root term, and the associated terms are represented as leaf terms; creating an ontology of terms and their inter-associations based on selective authoritative text; calculating term weights based on ontology and taxonomy; putting the context generation process in a feedback loop with the ontology generation process, resulting in term weights' refinement in each round of summarization, until an optimal weights' stability is achieved; and summarizing the documents in the corpus and storing it for further use.

3. The method of claim 2, wherein the said Ontology creation process comprises: cleaning the corpus; parsing the corpus using Natural Language Parsing techniques such as part of speech tagging; extracting and categorizing the key terms; concepts identification; relationships identification and terms association using techniques such as discovery of relations using existing databases such as Wordnet, association rule mining, terms' co-occurrence frequency based associations, frequency based discovery and associations for compound terms or phrases, relating compound nouns using the head noun term, etc.; and ontology construction and storage.

4. The method of claim 2, wherein the calculation of term weights comprises:
leaf term global weights calculation using the pre-calculated weights of the associated root terms along with the leaf term's ontology; using calculated leaf term weights to refine the global weights of the associated root terms; calculating global weights for terms not present in the taxonomy using only ontology; and calculating local weights of the constituent terms in a document by using the local frequency and global weights of the terms.

5. The method of claim 1, wherein said summary generation further comprises of: generating a list of sentences with corresponding weights that are calculated by using the constituent words' weights; pruning sentences based on sentence entropy that is calculated using factors such as number of weighted words in the sentence, total number of words in the sentence and the sentence weight; pruning of said sentences based on the document structure and the sentence position in the document; pruning of the said sentences based on a given probability distribution; selection of unique identifiers in a sentence that at least are also present in adjacent sentences and belong to the same semantic-group whereby adjacent sentences have related meaning; parsing the sentences using Natural Language Parsing techniques to identify their grammatical content for making similar sentences adjacent; replacing the sentences by similar sentences from the context database based on multitude of factors and, adding them together to form a summary.

6. The method of claim 1, wherein the said context is used for; summarizing a new document that is not present in the corpus; and creating multi-document summary as an answer to a user query.

7. The method of claim 5, wherein the answer generation comprises of:
using a variety of methods including Vector Space and Clustering and choosing the sentences based on a voting mechanism; refining answers by using an available ontology of concepts, and by improving the answer-generation mechanism that in turn uses optimization techniques on the metrics provided by tools that compare user summaries with machine generated summaries; using the top n summaries that match the question where n is smaller than the total number of retrieved results (N) for creating an answer.

8. The method of claim 5 wherein said summary and answer can vary depending upon the social network to which the initiating user belongs; and the language of the user.

9. The method of claim 1, wherein the storage, retrieval and usage of said summary further comprises: storing said summary in multitude of ways that at least include storage in a database against a Universal Resource Identifier and embedding in the structure of said electronic data to be summarized; indexing the summaries using a search engine; re-formatting of said summary for suitable access by resource locators/search engines/browsers, and for display on request whereby saving user time and computing resources; displaying summary near the corresponding URI (Uniform Resource Identifier);displaying said summary based on user preferences at least comprising of means of traversal from simpler summaries to complex summaries and from one summary to another using associated Uniform Resource Identifiers; storing said summary on a server or any other software/hardware platform and using it in a multitude of ways that at least include searching summaries based on input key text; monetizing publishing/consuming of summaries; modifying or ranking summary based on user input and publishing as per user request; and displaying similar summaries of different electronic data by resource locators/search engines/browsers; combining said summary with at least summary of similar electronic data and user provided summary to create a topic-summary.

10. A system comprising:
Means adapted for summarizing text(s), and using the generated summary as an answer to an input query, where summarization is based on a pre-generated context of a summarized authoritative texts corpus,
whereby said summary or answer prevents ‘denial of information’ and information overload when plurality of electronic data is available.

11. The system of claim 10, wherein the generation of said context further comprises: classifying input document key terms into unique concept groups using a taxonomy, where each concept is represented by a root term, and the associated terms are represented as leaf terms; creating an ontology of terms and their inter-associations based on selective authoritative text; calculating term weights based on ontology and taxonomy; putting the context generation process in a feedback loop with the ontology generation process, resulting in term weights' refinement in each round of summarization, until an optimal weights' stability is achieved; and summarizing the documents in the corpus and storing it for further use.

12. The system of claim 11, wherein the said Ontology creation process comprises: means adapted for cleaning the corpus; means adapted for parsing the corpus using Natural Language Parsing techniques such as part of speech tagging; means adapted for extracting and categorizing the key terms; means adapted for concepts identification; means adapted for relationships identification and terms association using techniques such as discovery of relations using existing databases such as Wordnet, association rule mining, terms' co-occurrence frequency based associations, frequency based discovery and associations for compound terms or phrases, relating compound nouns using the head noun term, etc.; and ontology construction and storage.

13. The system of claim 11, wherein said term weights' calculation comprises of: means adapted for leaf term global weights calculation using the pre-calculated weights of the associated root terms along with the leaf term's ontology; means adapted for using calculated leaf term weights to refine the global weights of the associated root terms; means adapted for calculating global weights for terms not present in the taxonomy using only ontology; and means adapted for calculating local weights of the constituent terms in a document by using the local frequency and global weights of the terms.

14. The system of claim 10, wherein said summary generation means further comprises of: means adapted for generating a list of sentences with corresponding weights that are calculated by using the constituent words' weights; means adapted for pruning sentences based on sentence entropy that is calculated using number of weighted words in the sentence, total number of words in the sentence and the sentence weight; means adapted for pruning of said sentences based on the document structure and the sentence position in the document; means adapted for pruning of the said sentences based on a given probability distribution; means adapted for selecting unique identifiers in a sentence that at least are also present in adjacent sentences and belong to the same semantic-group whereby adjacent sentences have related meaning; means adapted for parsing the sentences using Natural Language Parsing techniques to identify their grammatical content for making similar sentences adjacent; means adapted for replacing the sentences by similar sentences from the context database based on multitude of factors and, adding them together to form a summary.

15. The system of claim 10, wherein the usage means of the said context comprises: means adapted for summarizing a new document that is not present in the corpus; and means adapted for creating multi-document summary as an answer to a user query.

16. The system of claim 15, wherein the answer generation comprises of:
means adapted for using a variety of methods including Vector Space and Clustering and choosing the sentences based on a voting mechanism; means adapted for refining answers by using an available ontology of concepts, and by improving the answer-generation mechanism that in turn uses optimization techniques on the metrics provided by tools that compare user summaries with machine generated summaries; means adapted for using the top n summaries that match the question where n is smaller than the total number of retrieved results (N) for creating an answer.

17. The system of claim 15, wherein said summary and answer can vary depending upon the social network to which the initiating user belongs; and the language of the user.

18. The system of claim 10, wherein the storage, retrieval and usage of said summary further comprises: means adapted for storing said summary in multitude of ways that at least include storage in a database against a Universal Resource Identifier and embedding in the structure of said electronic data to be summarized; means adapted for indexing the summaries using a search engine ; means adapted for re-formatting of said summary for suitable access by resource locators/search engines/browsers, and for display on request whereby saving user time and computing resources; means adapted for displaying summary near the corresponding URI (Uniform Resource Identifier); means adapted for displaying said summary based on user preferences at least comprising of means of traversal from simpler summaries to complex summaries and from one summary to another using associated Uniform Resource Identifiers; storing said summary on a server or any other software/hardware platform and using it in a multitude of ways that at least include searching summaries based on input key text; monetizing publishing/consuming of summaries; modifying or ranking summary based on user input and publishing as per user request; and displaying similar summaries of different electronic data by resource locators/search engines/browsers; means adapted for combining said summary with at least summary of similar electronic data and user provided summary to create a topic-summary.

19. A computer readable medium of instructions comprising:
instructions for summarizing text(s), and using the generated single-source or multi-source summary as an answer to an input query, where summarization is based on a pre- generated context of a summarized authoritative texts corpus,
whereby said summary or answer prevents ‘denial of information’ and information overload when plurality of electronic data is available.

20. The computer readable medium of instructions of claim 19, wherein the generation of said context further comprises: instructions for classifying input document key terms into unique concept groups using a taxonomy, where each concept is represented by a root term, and the associated terms are represented as leaf terms; instructions for creating an ontology of terms and their inter-associations based on selective authoritative text; calculating term weights based on ontology and taxonomy; instructions for putting the context generation process in a feedback loop with the ontology generation process resulting in term weight's refinement in each round of summarization, until an optimal weights' stability is achieved; and instructions for summarizing the documents in the corpus and storing it for further use.

21. The computer readable medium of instructions of claim 20, wherein the said Ontology creation process comprises: instructions for cleaning the corpus; instructions for parsing the corpus using Natural Language Parsing techniques such as part of speech tagging; instructions for extracting and categorizing the key terms; instructions for concepts identification; instructions for relationships identification and terms association using techniques such as discovery of relations using existing databases such as Wordnet, association rule mining, terms' co-occurrence frequency based associations, frequency based discovery and associations for compound terms or phrases, relating compound nouns using the head noun term, etc.; and ontology construction and storage.

22. The computer readable medium of instructions of claim 20, wherein the calculation of term weights comprises: instructions for leaf term global weights calculation using the pre-calculated weights of the associated root terms along with the leaf term's ontology; instructions for using calculated leaf term weights to refine the global weights of the associated root terms; instructions for calculating global weights for terms not present in the taxonomy using only ontology; and instructions for calculating local weights of the constituent terms in a document by using the local frequency and global weights of the terms.

23. The computer readable medium of instructions of claim 19, wherein said summary generation further comprises of: instructions for generating a list of sentences with corresponding weights that are calculated by using the constituent words' weights; instructions for pruning sentences based on sentence entropy, that is calculated using the number of weighted words in the sentence, total number of words in the sentence and the sentence weight; instructions for pruning of said sentences based on the document structure and the sentence position in the document; instructions for pruning of the said sentences based on a given probability distribution; instructions for selection of unique identifiers in a sentence that at least are also present in adjacent sentences and belong to the same semantic-group whereby adjacent sentences have related meaning; instructions for parsing the sentences using Natural Language Parsing techniques to identify their grammatical content for making similar sentences adjacent; replacing the sentences by similar sentences from the context database based on multitude of factors and, instructions for adding them together to form a summary

24. The computer readable medium of instructions of claim 19, wherein the said context is used for; instructions for summarizing a new document that is not present in the corpus; and instructions for creating multi-document summary as an answer to a user query.

25. The computer readable medium of instructions of claim 24, wherein the answer generation comprises of: instructions for using a variety of methods including Vector Space and Clustering and choosing the sentences based on a voting mechanism; instructions for refining answers by using an available ontology of concepts, and by improving the answer-generation mechanism that in turn uses optimization techniques on the metrics provided by tools that compare user summaries with machine generated summaries; instructions for using the top n summaries that match the question where n is smaller than the total number of retrieved results (N) for creating an answer.

26. The computer readable medium of instructions of claim 24, wherein said summary and answer can vary depending upon the social network to which the initiating user belongs; and the language of the user.

27. The computer readable medium of instructions of claim 19, wherein the storage, retrieval and usage of said summary further comprises: instructions for storing said summary in multitude of ways that at least include storage in a database against a Universal Resource Identifier and embedding in the structure of said electronic data to be summarized; instructions for indexing the summaries using a search engine; instructions for re-formatting of said summary for suitable access by resource locators/search engines/browsers, and for display on request whereby saving user time and computing resources; instructions for displaying summary near the corresponding URI (Uniform Resource Identifier); instructions for displaying said summary based on user preferences at least comprising of means of traversal from simpler summaries to complex summaries and from one summary to another using associated Uniform Resource Identifiers; instructions for storing said summary on a server or any other software/hardware platform and using it in a multitude of ways that at least include searching summaries based on input key text; monetizing publishing/consuming of summaries; instructions for modifying or ranking summary based on user input and publishing as per user request; and displaying similar summaries of different electronic data by resource locators/search engines/browsers; combining said summary with at least summary of similar electronic data and user provided summary to create a topic-summary.
